(19) United States
(12) Patent Application Publication
(10) Pub. No.: US 2007/0192671 A1
(43) Pub. Date: Aug. 16, 2007

(54) DOCUMENT MANAGEMENT SYSTEMS

(76) Inventor: Jerry RUFENER, Cool, CA (US)

Correspondence Address: IRELL & MANELLA LLP, 1800 AVENUE OF THE STARS, SUITE 900, LOS ANGELES, CA, 90067, US

(21) Appl. No.: 11/536,618

(22) Filed: Sep. 28, 2006

Related U.S. Application Data
(60) Provisional application No. 60/772,555, filed on Feb. 13, 2006.

(51) Int. Cl. G06F 17/00; G06Q 10/00; G06F 17/30

(52) U.S. Cl. 715/500; 715/530; 715/531; 705/1; 707/1

(57) ABSTRACT

A document management technique includes a database of text strings, a document templates in the form of a doubly link or other list of text strings in the text string database which include attribute codes related to editing, approving, and displaying or printing test strings. Revised templates and text strings are saved as new templates and text strings so that the version of the document before any particular revision may easily be tracked and reproduced.

### CROSS REFERENCE TO RELATED APPLICATION

This application claims the benefit of the filing date of U. S. provisional patent application 60/772,555 filed Sep. 29, 2005.

### BACKGROUND OF THE INVENTION

1. Field of the Invention

This invention is related to document management systems and, more particularly, to computer based document creation, editing and management systems.

2. Description of the Background

Although there are many computer programs which aid in the development and management of documents, many document uses require that in final form the document be created as a hard or paper copy. For example, the Injury and Illness Prevention Program (IIPP) is a program required of California employers. Utilizing a checklist, brokers and policy holders navigate through a series of inquiries enabling them to evaluate their IIPP program for such, essential items as a written program and training requirements. The program must classify their industry according to one of five industry groups: Trades and Services, Agriculture, Manufacturing, Construction, and Public Agencies.

Traditionally, the IIPP has been carried out using paper forms. However, conventional implementation techniques are unwieldy because the pre-generated paper forms and documents are not easily modifiable and, when updates are made to them, a user must manually go through the forms and documents and replace outdated forms and documents by hand. Such manual updating is difficult to maintain and control.

What is needed is an improved document management system for producing an easily created, updated, maintained and traceable final copy of a document.

### SUMMARY OF THE INVENTION

In accordance with a first aspect, a method for managing a document may include providing a database of text strings, providing a document template in the form of a list of at least some of the text strings in the text string database, the list including a first, a last and intermediate text strings, each text string in the list except the first providing a link to a prior text string and each text string in the list except the last providing a link to a subsequent text string, each listed text string including attribute codes indicating if the related text string may be edited, if the related text string is required in a final document to be produced from the document template and any approvals required for the modification of the text string for use in the document to be produced from the document template, providing a user interface permitting a user to access and revise the document template, saving the revised document template as a new template, saving revised text strings as new text strings in the text string database and revising the document template list to include such revised text strings and producing the document from the revised document template in accordance with the database of text strings.

The list may include a global formatting command to be applied to the document to be produced from a document template. Some of the listed text strings may include text string formatting commands to be applied to the related text strings in the documents to be produced from the document template. The attribute codes may indicate that the related text string is to be displayed to the user during revision of the document template but not included in the document to be produced from the revised document template.

The technique may include automatically detected revisions to a text string, creating a copy of the text string being revised, applying the revisions to the copy of the text string and updating the list so that the text string, prior to the text string being revised, provides a link to the revised text string as the subsequent text string. The technique may also include maintaining an archival store of the text string database including saved revised text strings, the document template and the revised document template to provide an historical record of revisions made to the document and the ability to produce the document as revised at any point in a series of revisions. The user interface may permit the user to access and revise the document template on a client computer and the text string database and document template may be stored on a server computer connected by a network to the client computer. The document may be produced in a portable document format (PDF) file format and/or at least one text string may be in a markup language file format. The list may be a doubly linked list.

In another aspect, a document management system may include a database of text strings, a plurality of document templates, each in the form of a list of text strings in the text string database, the list including a first, a last and intermediate text strings and each text string in the list except the first providing a link to a prior text string in the list and each text string in the list except the last providing a link to a subsequent text string in the list, each listed text string including attribute codes indicating if the related text string may be edited, if the related text string is required in a final document to be produced from the document template and any approvals required for the modification of the text string for use in the document to be produced from the document template, a user interface providing access to revise at least one of the plurality of document templates and software controlling the user interface and saving the revised document template as a new template, saving revised text strings as new text strings in the text string database and revising the document template list to include such revised text strings and producing the document from the revised document template in accordance with the database of text strings.

The list may include a global formatting command to be applied to the document to be produced from a document template. The listed text strings may include text string formatting commands to be applied to the related text strings in the documents to be produced from the document template. The attribute codes for at least some of the listed text strings may indicate that the related text string is to be displayed to the user during revision of the document template but not included in the document to be produced from the revised document template.

Software may be provided for automatically detecting a revision to a text string, creating a copy of the text string being revised, applying the revisions to the copy of the text string and updating the list so that the text string, prior to the text string being revised, provides a link to the revised text string as the subsequent text string. An archival store may be used to maintain a copy of the text string database including saved revised text strings, the document template and the revised document template to provide an historical record of revisions made to the document and the ability to produce the document as revised at any point in a series of revisions.

A client computer may be provided on which the user interface resides and a server computer, connected by network to the client computer, may be provided on which the text string database and document template are stored. The document may be produced in a portable document format (PDF) file and/or a markup language file format while the list is a doubly linked list.

### BRIEF DESCRIPTION OF THE DRAWINGS

FIG. 1 is a flowchart of a document management process in accordance with an exemplary embodiment;

FIG. 2 is a schematic block diagram of an exemplary architecture for implementing embodiments of a document management process in accordance with an embodiment;

FIG. 3 is a schematic block diagram of an exemplary server for use in implementing a document management system in accordance with an embodiment;

FIG. 4 is a schematic block diagram of an exemplary client for use in implementing a document management system in accordance with an embodiment;

FIG. 5 is a schematic block diagram of an illustrative template that may be implemented in a document management process in accordance with one embodiment;

FIG. 6 is a flowchart of a process for generating a document in accordance with one embodiment;

FIG. 7 is a flowchart of a process for editing a template in accordance with one embodiment;

FIG. 8 is a block diagram representation of the process set forth in the flowchart of FIG. 7;

FIG. 9 is a flowchart of an exemplary template creation and review process in accordance with one embodiment;

FIG. 10 is a flowchart of a process for building an injury and illness prevention program in accordance with one embodiment;

FIG. 11 is a state diagram for an exemplary manual editing console in accordance with an embodiment;

FIG. 12 is a state diagram for an exemplary content management console in accordance with an embodiment; and

FIG. 13 is a block diagram outline of document system 1300.

### DETAILED DESCRIPTION OF THE PREFERRED EMBODIMENT(S)

The disclosed techniques for implementing a document management may be utilized for generating a document from a template and user input. A template may be provided that includes a set of one or more associated data elements and a linked list having a link to each data element. When the template is accessed by a user, the linked list may be copied to create a copy of the linked list with the copy of the linked list having its own separate links to the data elements separate from the links of the original version linked list. The copy of the linked list may then be used to access the set of data elements and the data elements may be combined with input obtained from a user to generate a document therefrom.

The generated document may then be presented to the user. For example, a copy of the generated document may be printed out for the user. In one implementation, the document may be generated in a portable document format (PDF) file format. In another implementation, at least one of the data elements of the set of data elements may be in a markup language file format (e.g., XML).

In another embodiment, when the initiation of an edit to a data element (i.e., an “original” data element) in the set of one or more data elements is detected, a new copy of the data element may be created so that the edit is made in the new copy of the data element leaving the original data element unmodified. In this embodiment, the link to the original version of the data element in the copy of the linked list is modified so that the link points to the copied data element instead of the original unmodified version of the data element. In such an embodiment, a notification may also be generated in order to indicate the modification of the template. This notice can then be sent, for example, any previous users of the template, or related documents, that may have previously generated a document from this template prior to the making of the edit. In a further embodiment, the edit may be reviewed by a user by accessing the new copy of the data element and, if the edit is approved by the user, the copy of the linked list can then be published so that future users of the template have access to the edited copy of the data element rather than the original version of the data element.

In one embodiment, the linked list, the copy of the linked list and the data elements may reside at a server. In another embodiment, the original linked list may be copied to a client from a server (that is coupled to the client via a network, for example). In such an embodiment, the set of data element(s) may reside at the server (and, thus, may not reside on the client). In another embodiment, each data element may have a permission associated therewith. In a further embodiment, the linked list comprises a doubly-linked list.

Embodiments of a document management system, process and architecture are described. In one embodiment, this architecture may be implemented so that a user can prepare a document such as the California OSHA required Injury and Illness Prevention Program (IIPP). In such an implementation, once a user is logged in, the user can input its policy number so that the architecture can retrieve pertinent information for the user such as, the nature of the user's business (the industry, the classifications under which its employees are paid, nature of past claims, etc.). The user may then be prompted for additional information through a questionnaire. At this point a draft IIPP is produced. The application then has a work flow by which the draft IIPP may be reviewed and edited by people whose rights are prescribed based on their respective roles. Some users may be limited to the role of a reviewer while other users may be able to actually edit the IIPP, commit the changes, and save the final product.

### Process Overview

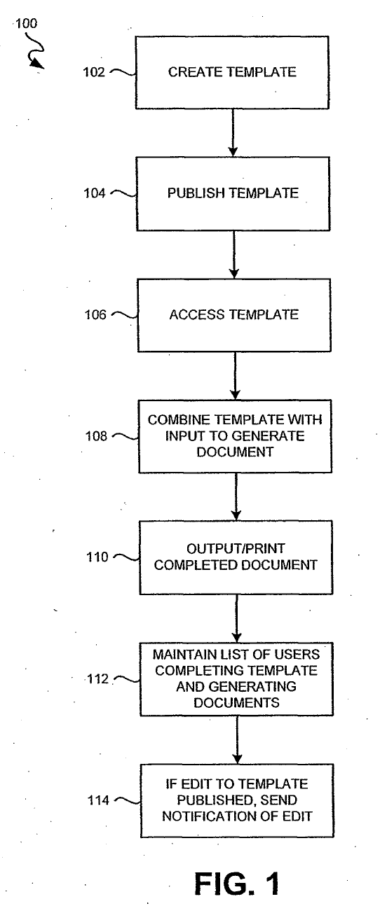

Referring now to FIG. 1, a flowchart is shown of an exemplary document management process 100. A template (that can be used to generate a document) may be created/obtained in operation 102. Once created, the template may be published in operation 104 so that the template is available for an end user to access in operation 106. In operation 108, input obtained from the user may be combined with the accessed template to generate a document that can be output in operation 110 for viewing (e.g., displaying), printing and/or storing on a computer readable medium. In one embodiment, the generated document may be output as a Portable Document Format (PDF) file.

As a further option, in operation 112, a record associating the user with the generated document may be maintained in, for example, a list for future reference. This record may be used, for example, to notify the user of any subsequently published changes to the template (see operation 114) so that the user may access the new version of the template and generate an updated version of the document that may incorporate the changes made to the template.

### Architecture

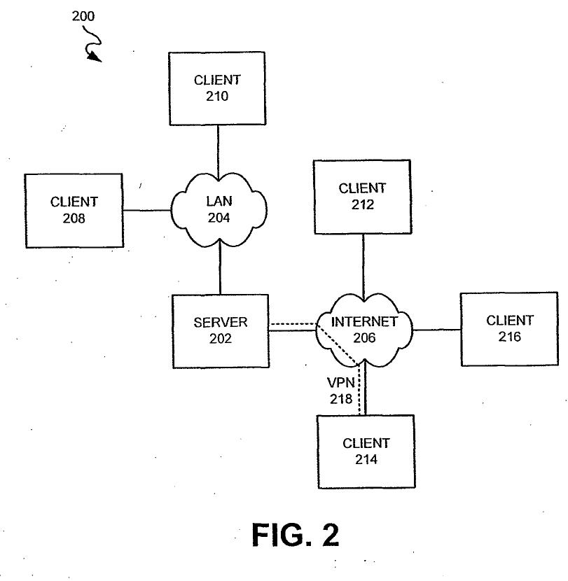

Referring now to FIG. 2, an exemplary architecture is shown for implementing embodiments of a document management process (such as, e.g., the process 100 depicted in FIG. 1). The architecture 200—may include a server 202 coupled to one or more networks 204, 206 such as, for example, a private or local area network 204 (LAN) and/or a public or wide area network 206 (WAN) such as the Internet.

One or more clients 208, 210, 212, 214, 216 may also be coupled to the networks 204, 206 to facilitate communication between the clients 208, 210, 212, 214, 216 and the server 202. For convenience, clients 208, 210, coupled to the LAN may be referred to as internal clients while clients 212, 214, 216 coupled to the Internet may be referred to as external clients. However, a client (e.g., client 214) coupled to the server 202 via the Internet 206 may also be considered as an internal client through implementation of a virtual private network 218 (VPN). While FIG. 2 depicts the internal clients 208, 210 as being coupled only to the LAN 204, it should be understood by one of ordinal skill in the art that these internal clients 208, 210 may also be coupled to the Internet as well, either directly or indirectly.

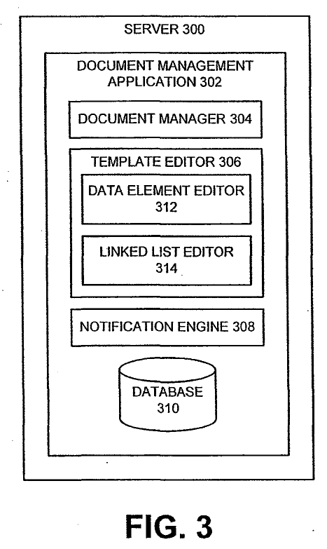

Referring now to FIG. 3, an exemplary server 300 is depicted that may be implemented in the document management architecture 200 of FIG. 2. The server 300 may also include a document management application 302 for use in implementing a document management process. The document management application 302 may include a document manager 304 for generating and presenting documents, a template editor 306 for facilitating the creating and editing (e.g. modifying) of templates and a notification engine 308 for generating notifications when a template has been modified. The document management application 302 may also be coupled to and/or include (as shown in FIG. 3) a database 310 for storing and retrieving data therefrom.

The document manager 304 may serve as an interface between the clients (e.g., clients 208, 210, 212, 214, 216, 218 of FIG. 2) and the template editor 306, the notification engine 308 and/or the database 310. The document manager 304 may also be responsible for enabling the presenting of templates (or portions thereof) to the clients, the receiving or obtaining of input in response to the templates back from the client, and the generating (and presenting) of documents based on the templates and the received input.

The template editor 306 may be implemented for creating and editing templates used in the document management architecture. In one embodiment, the template editor 306 may be implemented so that it includes a data element editor 312 for creating and editing data elements portions of a template as well as a linked list editor 314 for creating and editing or modifying the linked lists portions of a template.

The notification engine 308 may be implemented for monitoring the template editor 306 to detect events where a template have been edited (or, alternatively, to receive some sort of indication from the template editor that indicates that an edit has been made to a template). The notification engine 308 may then generate a notification of the edit that can be sent to the clients and/or past users of the template so that they can be notified of the change to the template.

While the components of the document management application 302 have been depicted as being implemented in the server 300, it should be understood to one of ordinary skill in the art that at least a portion of the document management application may also be implemented in one of the clients.

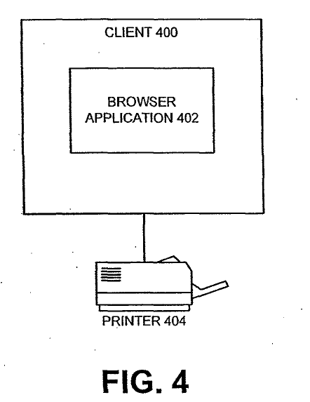

Referring now to FIG. 4, an exemplary client 400 is depicted that may be implemented in the document management architecture 200 of FIG. 2. A client 400 may include a browser application 402 (such as, e.g., MS Internet Explorer) to facilitate navigation and communication through the network(s) and to serve as an interface with applications hosted by the server. A client may also have peripheral devices coupled, such as, for example, a printer 404. In one implementation, some or all of these clients may comprise what is known in art as thin clients.

### Template

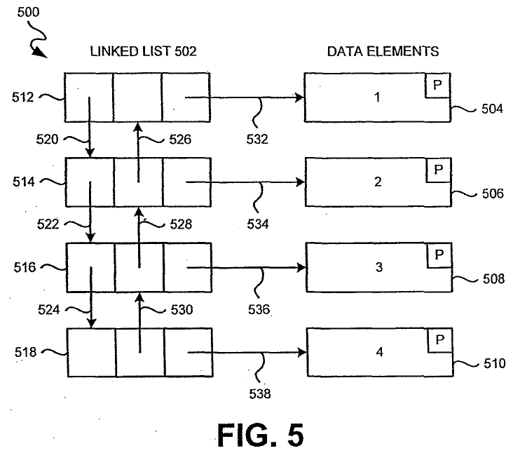

Referring now to FIG. 5, an illustrative template 500 is depicted that may be utilized in a document management process. This template 500 comprises a linked list 502 and an associated set of data elements 504, 506, 508, 510. More particularly, the linked list 502 may comprise a doubly linked list having a plurality of nodes 512, 514, 516, 518 with each of these nodes except of course the first and last or head and tail node having links (i.e., a pointer or reference) to the adjacent subsequent node (e.g., links 520, 522, 524) as well as links to the adjacent preceding node (e.g., links 526, 528, 530). Each of the nodes 512, 514, 516, 518 also has a link 532, 534, 536, 538 to an associated data element 504, 506, 508, 510 so that each data element can be accessed via its link from the associated node. The data elements of the template may be published in a mark-up language format (e.g., HTML, XML, etc.) so that they may be accessed via a browser application on a client. In one implementation, a data element may also include property and/or permissions information (represented by the instances of the letter “P” in FIG. 5) that can be used to associate/define properties and/or permissions to the given data element. Using this implementation of a template, various features of the document management process may be implemented.

A linked list may also include head and tail nodes (or starting and ending nodes) that each have a link to a-single node rather than to two nodes with the head node-having a link to a subsequent node and the tail node having a link to a preceding node. A linked list may comprise a singly-linked list, circularly-linked list or a doubly-linked list (as previously described). The singly-linked list has one link to another node with each node's link pointing to the next node in the list (or to a null value or empty list if it is the last node). In a circularly-linked list, the first and last nodes are linked together. A circularly-linked list may be implemented for both singly and doubly linked lists. Linked lists may also include a sentinel node at the beginning and/or at the end of the list for simplifying operation of the linked list by ensuring that every node always has a previous and/or next node, and that every list (even one that contains pointers to no data elements) always has a head and tail node.

During execution of the linked list, the data elements may be accessed as each of their each corresponding nodes is encountered. For example, during execution of the illustrative linked list in FIG. 5, node 512 may be encountered, followed by node 514, then node 516 and then finally node 518. When node 512 is encountered, data element 504 may be accessed via the link 532 to this data element 504. Then, when node 514 is encountered, data element 534 may be accessed via the link 534, and so on.

### Document Generation

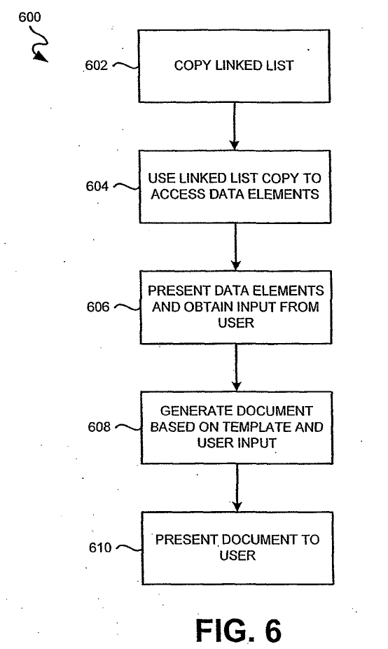

Referring now to FIG. 6, a flowchart of a process 600 is shown for generating a document using a linked-list template implementation (e.g., template 500 of FIG. 5). When a template (residing on a server, for example) is accessed in order to generate a document, rather than copying the entire template, only the linked list of the template may be copied in operation 602 with the data element links of the copied linked list pointing back to the data elements. Thus, at the completion of operation 602, there are two copies of the linked list with the nodes of both copies of the linked lists pointing back to the associated data element(s) residing on the server. In one embodiment, both copies of the linked list and the data elements may reside on the server. In another alternative embodiment, the original linked list can reside on a template-hosting server and the copied linked list may reside on a client computer with nodes of both copies of the linked lists pointing back to the associated data element residing on the server. With such an implementation of a template, the entire template does not have to be copied over to the client, merely a portion thereof such as the linked list.

In operation 604, the copy of the linked list may be used in order to access the data elements. In operation 606, the data elements may be presented to a user at the client computer according to the order that the linked list is run through while user input in response to (or as called for by) the presented data elements may also be collected. Operation 606 may be carried out, for example, using a browser application on the client.

Using the data elements (i.e., the template) and user input, a document may be generated in operation 608 and then presented to the user at the client in operation 610. In one implementation, the document may be generated first at the server and then sent to the client for presentment. In another implementation, the document may be generated at the client as the data elements are executed and the input is obtained without having to first generate the document at the server. Presenting the document in accordance with operation 610 may include displaying the completed document to the user at the client via the browser application, permitting the user to print out the completed document and/or permitting the user to store the completed document in a data store (e.g., a computer readable persistent memory device).

### Editing A Template

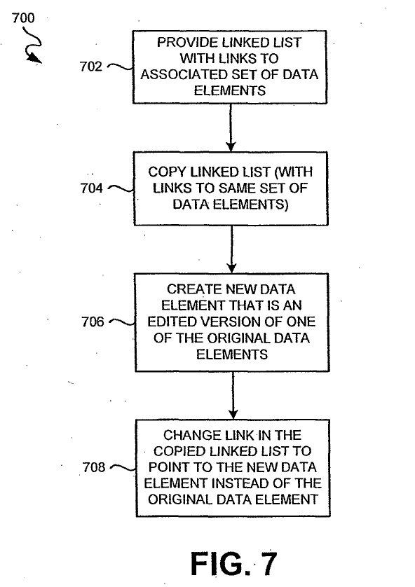

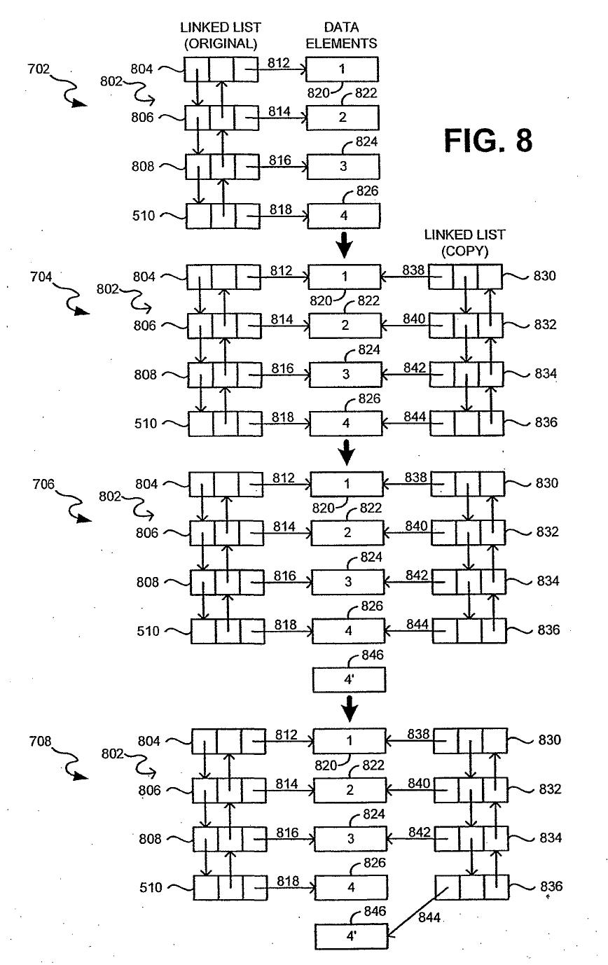

Referring now to FIGS. 7 and 8, the linked list implementation of the template may also provide a mechanism for managing the editing of templates in a data management process. FIG. 7 illustrates a flowchart of a process 700 for editing a template while FIG. 8 provides a block diagram representation of this process 700. With reference to FIGS. 7 and 8, in operation 702, a template is provided comprising a linked list 802 (e.g., a doubly linked list) with nodes 804, 806, 808, 810 of the linked list having corresponding links 812, 814, 816, 818 to associated data elements 820, 822, 824, 826 of the template.

In operation 704, when the template is accessed by a user, a copy 828 of the linked list may be created with its nodes 830, 832, 834, 836 having links 838, 840, 842, 844 back to the same data elements 820, 822, 824, 826 as the original copy 802 of the linked list. When the copied linked list 828 is followed, the data elements may be accessed via the links 838, 840, 842, 844 and presented to the user (e.g., via the browser application).

If the user makes an edit to a data element, the process continues to operation 706. In operation 706, when the user makes an edit to a data element 826 (i.e., data element 4 in FIG. 8), then a new data element 846 (i.e., data element 4′ in FIG. 8) is created containing the edit with the original version of the data element 826 left unmodified (i.e., in its original form without the edit). As shown in the implementation depicted in FIG. 8, this new version of the data element containing the edit may be created (and stored) at the server, however, it should be understood that an implementation of this process might be carried out with the new data element being created (and stored) at a client instead.

In operation 708, the link 844 of the node of the copied linked list is changed so that it now points to the new data element 846 instead of the original data element 826. Thus, in this manner, when the copy of the linked list 828 is subsequently run through in order to make a document (e.g., via the process 600 set forth in FIG. 6), the new data element 846 will be accessed (via link 844) instead of the original version of the data element 826.

In one implementation, the process 700 may further continue by having the copy of the version of linked list 828 stored (e.g., in the database) as a new version of the linked list so that other users may access the new version of the linked list (and thereby the new data element 846). It should also be noted that the original version of the linked list still maintains a link to the original data element 826, so that it may be possible for a user to retrieve the original form of the template without the edit. Similarly, by having both versions of the linked list maintained on the server, a user may be able to compare the two versions of the template through, for example, a comparative execution of both of the linked lists.

In addition, the process set forth in FIGS. 7 and 8 can easily be expanded for subsequent edits to the data elements/template. Namely, every time a data element is edited, a new copy of the data element will be created with the copy of the linked list of the subsequent user making the edit having its appropriate link modified to point to the new copy of the data element rather than the earlier version of the data element. For example, following from the example described in FIGS. 7 and 8, if a subsequent edit is made to data element 4′, a new version of the data element, data element 4″, may be created containing the new edit while data element 4′ is left unmodified. Similarly, had the subsequent user modified a different data element, say data element 3, then a new copy of data element 3, data element 3′ would be created containing the edit leaving data element 3 unmodified. In this example, the copy of the linked list for this user would have a link to data element 3′ instead of data element 3 (as well as data element 4′ instead of data element 4). In a further embodiment, a user may be able to go back and access the original version of the template without having to access the new data elements created by edits from other users. This way each user can make his or her own edits to each data element without having to encounter other users' edits to the data elements.

### Template Creation and Review

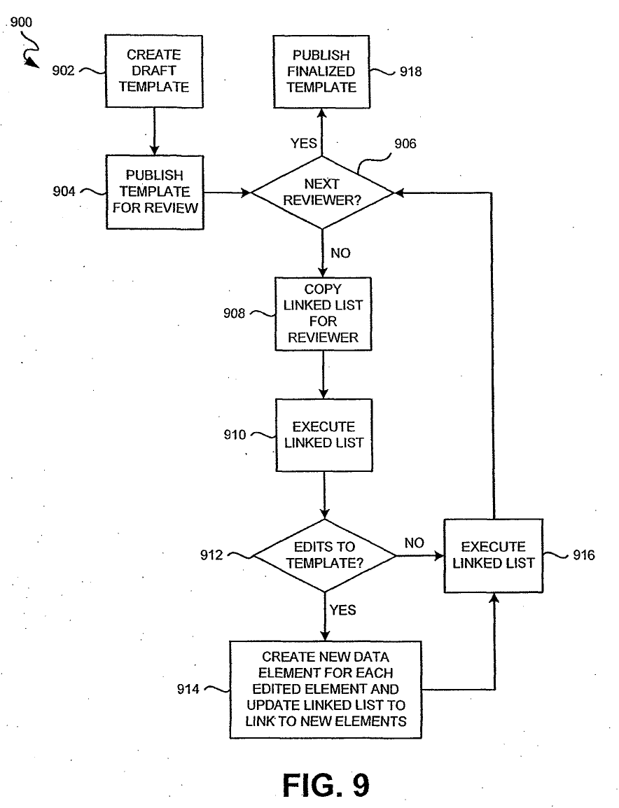

Referring now to FIG. 9, an exemplary template creation and review process 900 is illustrated that builds on the basic editing process described above with regard to FIGS. 7 and 8. With this creation and review process 900, several users can collaborate to create and edit a template that may then be published and used to generate documents. This process 900 may start at operation 902 with the creation of a draft template. In one embodiment, this draft template may be created by creating a plurality of data elements and a linked list (e.g., a doubly linked list) having nodes with links to the created data elements so that the data elements are associated with the nodes of the linked list. Alternatively, rather than creating a template completely from scratch, a copy of a linked list of an existing template may be used as the starting point in operation 902 (e.g., following a procedure similar to that set forth in operation 602 and 704 of FIGS. 6 and 7).

In operation 904, the created template may then be published for review by making the template accessible to one or more users. The review process begins with each reviewer following the “Yes” path of decision 906. In operation 908, a copy of the linked list is created for the reviewer in a manner similar to the described in operation 704 of FIG. 1. In operation 910, the copied linked list is run through (e.g., by the reviewer's browser application), by for example stepping through and processing each link in the list in sequence, to access and present the data elements of the template to the reviewer. If the reviewer has edits to any of the data elements (see decision 912), then in operation 914, a new data element may be created for each data element being edited by the review with the corresponding links of the reviewer's copied version of the linked list being updated to point to the newly created data elements instead of the original elements. Operation 914 may be carried out in a manner similar to that set forth in FIGS. 7 and 8.

If the reviewer has no edits or has finished making edits to the template, then the reviewer may approve the template in operation 916 and the review process may be repeated by the next reviewer. After all of the reviewers have approved the template, then the “No” path from decision 906 may be followed and the finalized version of the template may be published in operation 918 and thereby made available to end users for generating documents therefrom.

It should also be understood, that while the copy of the linked list 828 referenced in FIGS. 7 and 8 is shown in FIG. 8 to have been made on the client side process 700 may be implemented partially or completely on the server side and/or with a copy of the linked list being made on the server side instead of on the client side.

### Injury and Illness Prevention Program Builder

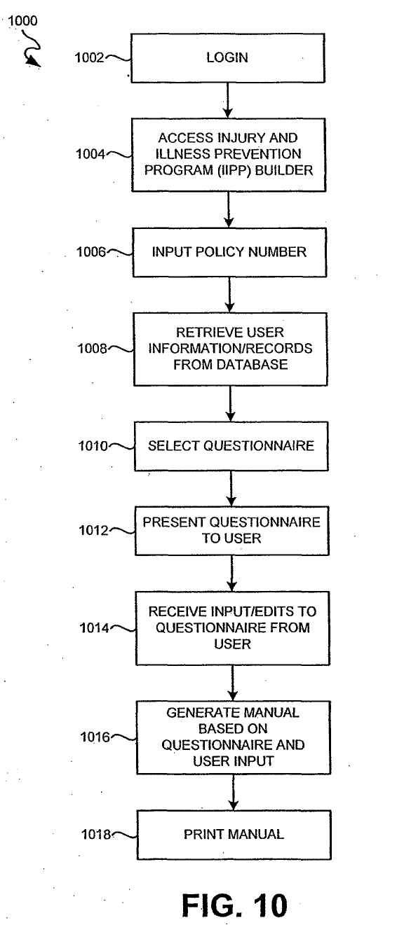

Referring now to FIG. 10, a flowchart is illustrated of a process for building an injury and illness prevention program, for example under the California IIPP utilizing an injury and illness prevention program builder application that may be implemented utilizing the previously described document management architecture and processes. In operation 1002, a login process is executed to log a user into a system hosting an injury and illness prevention program (IIPP) builder application. Once logged in, the user may access the IIPP builder application and launch a session with the IIPP builder application in operation 1004. In operation 1006, the user may be queried for a policy number (i.e., an account identifier) associated with a policy (i.e., an account) held by the user.

Based on the input policy number, information about the user and the policy may be retrieved from the system's database in operation 1008. A questionnaire may then be selected for presentment to the user in operation 1010 based on the information retrieved in operation 1008. In one embodiment, the questionnaire may be implemented as a template.

In operations 1012 and 1014, the questionnaire may then be presented to the user in order to receive input from the user to questions posed by the questionnaire as well as to receive any edits to the questionnaire the user may make. Based on the questionnaire/template and the input received from the user, an injury and illness prevention program or manual may be generated for the user in operation 1016 that provides information for preventing injuries and illnesses. In one embodiment, the manual may be generated in a portable document format (PDF) file format. The generated manual may then be presented to the user (e.g., via a download) so that the user may print out and/or store the manual in operation 1018.

The Injury and Illness Prevention Program (IIPP) builder application may be a web-based application for allowing organizations to create and maintain base services for presentation to policyholders. By accessing base services, policyholders will be able to create customized manuals in portable document format (PDF) and/or evaluate existing manuals to ensure compliance with current regulatory and legislative requirements. The IIPP Builder application may also be referred hereafter as the “system.” A “user” may represent an individual user of the system. A user may also be defined by attributes assigned to their policyholder or service. A user is a member of a policyholder. A user may belong to one policyholder and organization. A user may exist in a policyholder or an organization.

A role may be defined or viewed as a collection of permissions. Users may be assigned roles and the current role of a user can determine the scope of attributes used in the system. The System may include roles of “public,” “editor,” “reviewer,” and “manager.” A permission may be defined as the right to perform an action in the system. Permissions define the user's ability to access and operate the system. An attribute may represent a defined setting assigned to a policyholder, user, or base service by the system.

A policyholder may be defined as an entity that subscribes to a service provided by the organization. A policyholder manager may be a user with the right to operate on all users and sections, documents, paragraphs, and forms related to a policyholder. There may be one policyholder manager per policyholder and this manager may be designated by the organization. A group may be defined as an association of policyholders in the same industry. A primary associate may be defined as the primary policyholder of a group or trade association that provides group insurance policies. A unit may be an individual policyholder within a Group.

The organization may be defined as the entity hosting the IIPP Builder application. The organization manager may be a user with the right to operate on all users and sections, documents, paragraphs, and forms related to an organization. There may be one organization manager per organization. A service may represent a program that the organization administers and offers to policyholders (e.g., IIPP). Services may be customized to suit industry needs.

A standard industry code (SIC) is a code that may be assigned to a policyholder by a government agency. The SIC represents the industry classification of a policyholder. All Policyholders may be associated with a SIC and policyholders can have one or more industry classification. A governing class code (GCC) may be defined as the primary classification code assigned to a policyholder. A class code (CC) may comprise a two-digit industry classification code assigned to a policyholder.

A base service may be defined as a set of sections, documents, paragraphs, and forms approved by the organization as a template for a manual. Thus, a template may be a base service. A base service manager may be a user with the right to operate on all users and sections, documents, paragraphs, and forms related to a base service. There may be one base service manager per base service.

A manual may be a customized IIPP document in PDF format created from a base service by a user for a policyholder. A manual may be created from a template and user input. A manual manager may be a user with the right to operate on all users and sections, documents, paragraphs, and forms related to a manual. There may be one manual manager per manual. A section may comprise a collection of documents, paragraphs, and forms. A document may be a collection of paragraphs and forms while a paragraph may be a collection of text components. A document that can be printed and filled out may be referred to as a form. A service state may represent the current state of a user's work in the system. A metalink may represent an identifiable and embedded text item for replacement.

### IIPP Builder Functionality

The system may provide an organization with the ability to administer, create, edit, and maintain base services. An initial base service with requisite attributes may be provided and approved by the organization for inclusion in the system. The system can automatically process data retrieved by the organization. A user may supply credentials (e.g., user name, password, etc.) in order to log in the system.

### Organization

An organization can administer, create, edit, and maintain base services. A base service may be the published state by an organization of a collection of sections, documents, paragraphs, and forms. An organization can maintain several base services at a time. Base services can be offered to policyholders by an organization.

As previously mentioned, base services may comprise sections. Sections comprise of one or more documents. Documents comprise one or more paragraphs, base services, sections, documents, and paragraphs are defined by Attributes.

In one embodiment, base services may not be active in the system until approved by an authorized user for the organization. Once a base service has been approved, the base service can be published and made available for use by policyholders.

Organizations can be defined by attributes. Users may be assigned to an organization. Organizations also define Roles. Roles are assigned permissions and users can be assigned roles. Permissions define the ability to access and operate the system.

An organization may have one organization manager. An organization manager can transfer administrative rights to another user. The organization manager can also assign base service managers to base services. The organization manager can also be responsible for creating all users for an organization. The organization manager may also create base services for an organization. A base service manager may administer more than one base service. A base service may be limited to one manager. A user may have multiple roles. A base service manager may be responsible for assigning all users-and roles to a base service. The organization may also retain the master copy of the data of the system.

### Policyholders

Policyholders may be members of one organization. Users for a policyholder can create personalized and customized manuals. A Manual (e.g., a document) may be a customized version of a base service created for a particular policyholder. Policyholders may be defined by attributes. Attributes can guide the system to create customized manuals for the policyholder.

Users can be assigned to policyholders. A policyholder may have a policyholder manager that can transfer administrative rights to another user. The policyholder manager may be capable of assigning manual managers to manuals. A manual manager may administer more than one manual. A manual may be limited to one manager. A user may have multiple roles and a manual manager can be responsible for assigning all users and roles to a manual.

Manuals can be stored in the system in a service state status to allow updates in the timeframe allotted. Manuals may not be active in a system until approved by an authorized user for a policyholder. Once the manual has been approved by an authorized user, the manual can be published as a PDF-formatted file.

### Creating a Base Service

An organization may approve and provide initial base services for employers. When necessary, the organization can update and edit these base services to reflect new regulatory and legislative requirements.

### Creating a Manual

A user for a policyholder can create personalized and customized manuals using the system. After being presented with an overview of the contents required in all manuals, a user can answer a group of questions to further customize the document to fit their particular business and/or industry. With this information, the system can generate a manual from a base service. The user can customize the manual by adding, deleting, or editing content on a paragraph by paragraph basis. A wizard feature may be made available to the user to define terms and guide the user through the manual creation process. The user can then choose whether to accept or delete optional forms and supporting documents designed to ensure employee compliance with the IIPP. Once a final version of the manual is created, the user can save a copy to their file thereby making it available for secondary users to download and/or edit. A code of safe practices document, specialized for their industry, may also be generated.

Once the manual has been approved by an authorized user, the manual can be published as a PDF-formatted file. Companies with multiple locations can create and save manuals for each location. When regulatory and legislative requirements change, manuals may be automatically updated when changes are made to the base service. In one embodiment, a user will receive an e-mail notification informing them of recent changes and instructing them to make the updates to the appropriate manuals.

### Users

A policyholder manager may be designated by an organization and may be responsible for administering and managing associated accounts. The policyholder manager may also create or delegate responsibilities to other users. The policyholder manager can transfer administrative rights to another administrative user, or designee, although these rights may be a strict subset of the policyholder manager's privileges. The designee should not have more privileges than the corresponding policyholder manager.

A basic user may be capable of performing global edits. After filling out contact information, a basic user may be permitted to generate a basic manual from a base service. Data used to create global edits can be stored for future use. Basic users may also be able to bookmark their work, allowing them to return at a later session to make subsequent changes.

An advanced user may be permitted to create customized manuals from a base service by adding or substituting complete sections, or by adding, deleting, substituting, and/or modifying individual paragraphs. Local edits can be saved in a format that allows users to return to a completed manual to make modifications and updates. Advanced users may also be able to bookmark their work like a basic user.

An organization manager may be responsible for creating and managing users. The organization manager may also create or delegate responsibilities to other users and may also transfer administrative rights to another administrative user or designee. The transferred rights may be limited to a strict subset of the organization manager's privileges so that the designee does not have more privileges than the organization manager. In some embodiments, the organization manager may not be permitted to transfer “create user” rights to another user.

### Access Control

After being authenticated through a login process, a user can have access to features of the system through, for example, a link on an organization's website.

### Manual Evaluation and Help Applications

The system may also include a manual evaluation application that can present a Q&A process that guides a user through the elements of an IIPP and evaluates the user's current manual for compliance. Based on the information retrieved from this evaluation, this feature may allow users to add any required sections to their manual.

The system may also present a help maintenance console to provide instructions to authorized users on creating and maintaining help functions and content. The help maintenance console may be web-based and present a selectable paginated list of current help entries that can be reviewed and edited. The user may also be permitted to edit the current content or replace it with customized entries.

### Editing

Editing features may be included in the system and be used to modify a manual or base service. Edit functions can be provided on a paragraph-by-paragraph basis. As an option, paragraphs adjacent the paragraph being edited may also be presented to the user at the same time to help provide the user with some context when performing the edit.

Paragraphs may have one or more attributes associated therewith. Tables 1 and 2 present a set of exemplary paragraph attributes.

TABLE 1
Manual Editing Console

| Attribute | Attribute Definition |
|---|---|
| 1. Editable | User can edit |
| 2. Required | Cannot be deleted |
| 3. Controlled | Only the organization may edit |
| 4. Supporting | Paragraph giving the user guidance and/or |
| | information, but not actually appearing in the |
| | printed document (i.e., the completed |
| | manual) |

TABLE 2
Content Management Console

| Attribute | Attribute Definition |
|---|---|
| 1. Proposed | Paragraph that has not yet been approved |
| 2. Approved | Paragraph approved for use in a base service |
| 3. Archived | Retained obsolete paragraphs that may be |
| | used for instance to recreate a base service |

### Manual Editing Console (MEC)

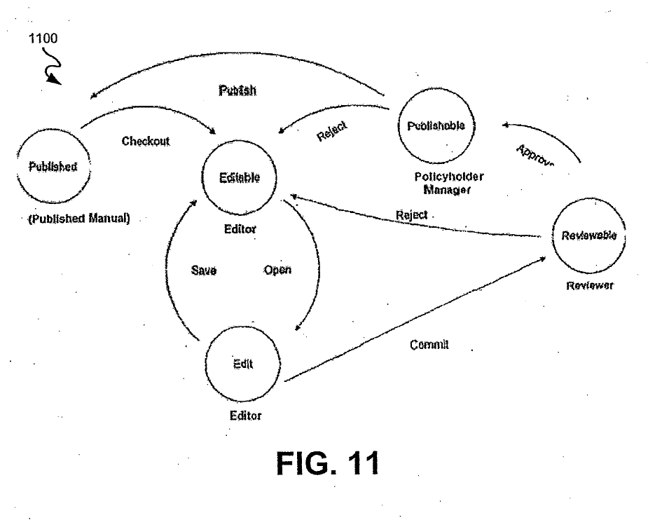

Referring now to FIG. 11, a Manual Editing Console (MEC) may be provided by the system to allow users of a policyholder to edit the Manual in a single document interface. Common controls, such as cut and paste as well as a spell/grammar checker application, may be included in the MEC. FIG. 11 shows a state diagram 1100 for an exemplary manual editing console (MEC). In this state diagram 1100, circles represent the various states and the arrows represent actions. The state diagram 1100 also includes a plurality of roles including, for example: public, editor, manager, and reviewer.

A user in a “public” role (i.e., a public user) in the state diagram 1100 may have access to the “published” state. In the “published” state, a “public” user may view a manual and retrieve a PDF version of the manual.

A user in an “editor” role (i.e., an editor) in the state diagram 1100 may have access to the “editable” and “edit” states. In the “published” state, an “editor” user may be able to checkout section(s) of the manual to the “editable” state. In the “editable” state, an “editor” user can open the section(s) to the “edit” state for editing. After editing, the “editor” user may either save the changes to the “editable” state, which will allow the user to return later to make more changes, or commit the changes to the “reviewable” state, where the proposed changes/edits will await review.

A user in a “reviewer” role (i.e., a reviewer) in the state diagram 1100 may have access to the “reviewable” state. In the “reviewable” state, a “reviewer” user can review the edited section(s). After reviewing, the “reviewer” user can then approve or reject the changes/edits made. If rejected, the section(s) can be moved back to the “editable” state with notes for revisions. If approved, the section(s) can be moved to the “publishable” state.

A user in a “manager” role (i.e., a manager) in the state diagram 1100 may have access to the “publishable” state. In the “publishable” state, a policyholder manager can publish or reject the manual. If rejected, the section(s) can be moved to the “editable” state for further revisions. If published, the manual can be moved to the “published” state, where it will supersede any previous version of the manual. In some implementations, previous manuals and change records can be archived in the system.

Table 3 presents a set of exemplary definitions for actions in the MEC state diagram 1100 depicted in FIG. 11.

TABLE 3
MEC Actions

| Action | Action Definition |
|---|---|
| Checkout | The process of selecting a section of a base service for editing. This |
| | action may be performed by an editor. |
| Open | The process of moving a section from the editable state to the edit state |
| | to initiate active editing. This action may be performed by an editor. |
| Save | The process of saving edits made to a section. This action moves the |
| | section from the edit state back to the editable state. This action may be |
| | performed by an editor. |
| Commit | The process of saving proposed sections and committing them to the |
| | reviewable state for reviewer approval. This action may be performed by an |
| | editor. |
| Reject | The process of rejecting edits back to the editable state for changes. |
| | This action may be performed by a base service manager or a reviewer. |
| Approve | The process of approving the proposed sections and moving them to the |
| | publishable state. This action may be performed by a reviewer. |
| Publish | The process of publishing an approved base service. This action may be |
| | performed by a base service manager. |

With further reference to FIG. 11, the “editable” state can be viewed by users in the “editor”, “manager,” and/or “reviewer” roles. The “editable” state is the state in which a section exists prior to active editing, after being saved, or after being rejected.

The “edit” state may be processed by users in the “editor” role. The “edit” state is the state where a section is edited. The “reviewable” state in another state that can be achieved by users in the “editor” role. In the “reviewer” state, edited sections wait for reviewer approval.

The “publishable” state can be achieved by users in the “reviewer” role and is the state where an approved section waits for manager approval. The “published” state can be achieved by users in the “manager” role. Published manuals exist in the “published” state and, once published (e.g., by a policyholder manager), the manual is available for use by policyholders.

### Content Management Console (CMC)

A Content Management Console (CMC) allows organizations to create original paragraphs and sections for a base service, and to modify existing paragraphs and sections as requirements change. Once a new section is created, it can be marked as “proposed” and may be used and edited by the organization. Once approved by the organization, the new section can be inserted into the appropriate place in the base service. When published, the base service will be moved to the “published” state, where it will supersede any previous version of the base service. Any previous base services can be archived in the system. Once published, the new base service is made active and available to policyholders.

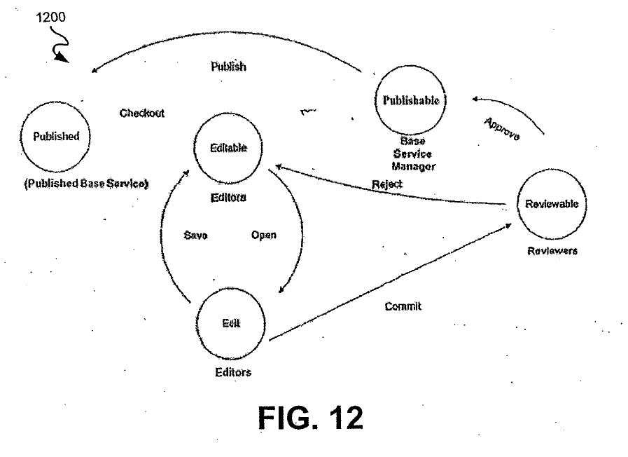

Referring now to FIG. 12, a state diagram 1200 is shown for an exemplary content management console (CMC). In this state diagram 1200, circles represent the various states and the arrows represent actions. The state diagram 1200 also includes a plurality of roles including, for example: public, editor, manager, and reviewer.

With continuing reference to FIG. 12, a user in a “public” role (i.e., a public user) in the state diagram 1200 may have access to the “published” state. In the “published” state, a “public” user can view a base service, retrieve a PDF-formatted version of the document, and/or view the change history (e.g., version history/tracking).

A user in the “editor” role (i.e., an editor) in the state diagram 1200 may have access to the “editable” and “edit” states. In the “published” state, an “editor” user may be permitted to checkout section(s) of the base service to the “editable” state in which the “editor” user can open the section(s) into the “edit” state for editing. After editing, the “editor” user can either save the changes to the “editable” state—which will allow the “editor” user to return later to make more changes—or commit the changes to the “reviewable” state, where the proposed changes will await review.

A user in the “reviewer” role (i.e., a reviewer) in the state diagram 1200 may have access to the “reviewable” state. In the “reviewable” state, a “reviewer” user may review the edited section(s). After reviewing, the “reviewer” user can approve or reject the changes made. If rejected, the section(s) may be moved back to the “editable” state with notes for revisions. If approved, the section(s) will be moved to the “publishable” state.

A user in the “manager” role (i.e., a manager) in the state diagram 1200 may have access to the “publishable” state. In the “publishable” state, a base service manager can publish or reject a base service. If rejected, the section(s) may be moved to the “editable” state for further revisions. If published, the base service will be moved to the “published” state, where it will supersede any previous versions of the base service. The previous base services can be archived in the system.

Table 4 presents a set of exemplary definitions for actions in the CMC state diagram 1200 depicted in FIG. 12.

TABLE 4
CMC Actions

| Action | Action Definition |
|---|---|
| Checkout | The process of selecting a section of a manual for editing. This |
| | action may be performed by an editor. |
| Open | The process of moving a section from the editable state to the edit |
| | state to initiate active editing. This action may be performed by an |
| | editor. |
| Save | The process of saving edits made to a section. This action moves the |
| | section from the edit state back to the editable state. This action may |
| | be performed by an editor. |
| Commit | The process of saving proposed sections and committing them to the |
| | reviewable state for reviewers approval. This action may be performed by an |
| | editor. |
| Reject | The process of rejecting edits back to the editable state for changes. |
| | This action may be performed by a policyholder manager or a |
| | reviewer. |
| Approve | The process of approving the proposed sections and moving them to |
| | the publishable state. This action may be performed by a reviewer. |
| Publish | The process of publishing an approved manual. This action may be |
| | performed by a policyholder manager. |

With further reference to the state diagram 1200 shown in FIG. 12, the “editable” state can be achieved by users in the “editor,” “manager,” and/or “reviewer” roles. The “editable” state is the state in which a section exists prior to active editing, after being saved, and/or after being rejected.

The “edit” state can be achieved by users in the “editor” role. Section(s) can be edited in the “edit” state. The “reviewable” state can be achieved by users in the “editor” role. In the “reviewable” state, proposed sections await reviewer approval.

The “publishable” state can be achieved by users in the “reviewer” role and this state is the condition in which an approved section waits for manager approval. The “published” state can be achieved by users in the “manager” role. Published base services exist in the “published” state, and once published, (e.g., by a base service manager), the base service is available for use by policyholders.

The various embodiments described herein may further be implemented using computer programming or engineering techniques including computer software, firmware, hardware or any combination or subset thereof. While components set forth herein may be described as having various sub-components, the various sub-components may also be considered components of the system. For example, particular software modules executed on any component of the system may also be considered components of the system. In addition, embodiments or components thereof may be implemented on computers having a central processing unit such as a microprocessor, and a number of other units interconnected via a bus. Such computers may also include Random Access Memory (RAM), Read Only Memory (ROM), an I/O adapter for connecting peripheral devices such as, for example, disk storage units and printers to the bus, a user interface adapter for connecting various user interface devices such as, for example, a keyboard, a mouse, a speaker, a microphone, and/or other user interface devices such as a touch screen or a digital camera to the bus, a communication adapter for connecting the computer to a communication network (e.g., a data processing network) and a display adapter for connecting the bus to a display device. The computer may utilize an operating system such as, for example, a Microsoft Windows operating system (O/S), a Macintosh O/S, a Linux O/S and/or a UNIX O/S. Those of ordinary skill in the art will appreciate that embodiments may also be implemented on platforms and operating systems other than those mentioned. One of ordinary skill in the art will also be able to combine software with appropriate general purpose or special purpose computer hardware to create a computer system or computer sub-system for implementing various embodiments described herein. It should be understood that the use of the term logic may be defined as hardware and/or software components capable of performing sequence(s) of functions. Thus, logic may comprise computer hardware, circuitry (or circuit elements) and/or software or any combination thereof.

Embodiments of the present invention may also be implemented using computer program languages such as, for example, ActiveX, Java, C, and the C++ language and utilize object oriented programming methodology. Any such resulting program, having computer-readable code, may be embodied or provided within one or more computer-readable media, thereby making a computer program product (i.e., an article of manufacture). The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by performing the code directly from one medium, by copying the code from one medium to another medium, or by transmitting the code over a network.

A browser is an application program that provides a way to look at and interact with all the information on the World Wide Web. The word “browser” seems to have originated prior to the Web as a generic term for user interfaces that let you browse (navigate through and read) text files online. A Web browser may be considered a client program that uses the Hypertext Transfer Protocol (HTTP) to make requests of Web servers throughout the Internet on behalf of the browser user. While some browsers also support e-mail (indirectly through e-mail Web sites) and the File Transfer Protocol (FTP), a Web browser may not be required for those Internet protocols, and more specialized client programs are more popular.

Based on the foregoing specification, embodiments of the invention may be implemented using computer programming or engineering techniques including computer software, firmware, hardware or any combination or subset thereof. Any such resulting program—having computer-readable code—may be embodied or provided in one or more computer-readable media, thereby making a computer program product (i.e., an article of manufacture) implementation of one or more embodiments described herein. The computer readable media may be, for instance, a fixed drive (e.g., a hard drive), diskette, optical disk, magnetic tape, semiconductor memory such as for example, read-only memory (ROM), flash-type memory, etc., and/or any transmitting/receiving medium such as the Internet and/or other communication network or link. An article of manufacture containing the computer code may be made and/or used by performing the code directly from one medium, by copying the code from one medium to another medium, and/or by transmitting the code over a network. In addition, one of ordinary skill in the art of computer science may be able to combine the software created as described with appropriate general purpose or special purpose computer hardware to create a computer system or computer sub-system embodying embodiments or portions thereof described herein.

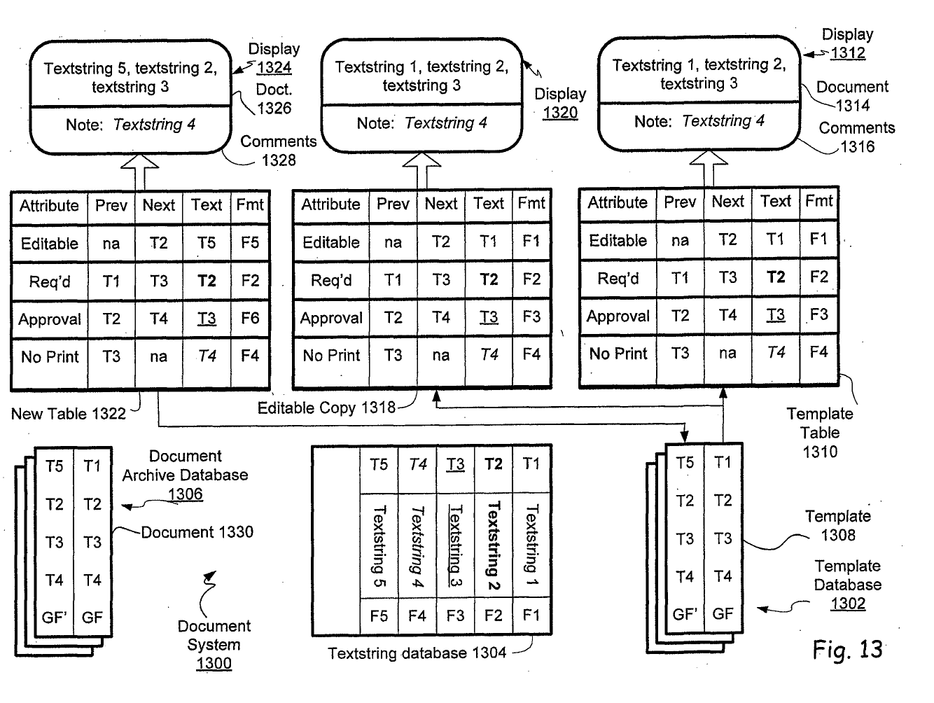

Referring now to FIG. 13, document management system 1300 includes template database 1302 and text string or textstring database 1304 which may be combined or separate. Document archive database 1306 may be combined with or separate from template database 1302. Template 1308 in template database 1302 may be a preexisting template in which text strings or textstrings T1, T2, T3 and T4 are combined, in that order, using a global format (GF). For the purposes of this explanation, each text string or textstring may be a word, a sentence or sentence fragment, a paragraph, a section of a document with one or more paragraphs and/or any other portion of document convenient for use with the template and editing functions of that particular document.

Template 1308 in template database 1302 contains the data shown in template table 1310. The top row in table 1310 illustrates the contents of each of the sections of the data in each row related to one of the textstrings. The first row of data in table 1310 is related to textstring T1 and specifies that, at least in template 1308 and reading from left to right, this textstring has the attribute that it is “editable”, there is no previous textstring in this template, the next textstring in the template is textstring T2, the text is textstring T1 and the textstring format is F1.

The text string or textstring format F1 includes the format data which overrides the general format, GF, which applies to template 1308. Format F1 may includes format data which applies to all of textstring T1 in this template and/or it may contain different format data for different portions of textstring T1 in this format. Similarly, each textstring may include more than text, such as icons, pictures and photos, graphs, graphics and/or other portions of a document to be produced.

The second row of template table 1310 specifies that the related text string or textstring has the attribute “required” and must therefore be included in the final document, that the previous textstring is textstring T1, the next textstring is textstring T3, the textstring is T2 and the textstring format in this template is F2. In the figure, the fact that a text string is required in the final document is emphasized in the figure by showing the textstring identifier in bold, i.e. T2.

The next row has the attribute “approval”, which is used to illustrate that certain textstrings may require a higher level of approval than others. For example, textstring T1 may be editable by anyone working on system 1300 while textstring T3 may require approval from a supervisory level person before it can be edited. The fact that a text string requires approval before editing (or before saving an edit) is emphasized in the figure by showing the textstring identifier underlined, i.e. T3. Textstring T3 comes after textstring T2, before textstring T4 and uses textstring format T3.

The final row of template table 1310 has the attribute “no print” indicating that it is to be displayed for use as instructions or information for the editor but will not be included when template 308 is printed. Textstring T4 comes after textstring T3 and is the last textstring illustrated in this template table. The fact that a text string is displayed but not printed in the final document is emphasized in the figure by showing the textstring identifier in italics, i.e. T4.

When the document based on template 1308 is displayed, for example, in display 1312, the display includes document 1314 as shown including textstrings T1, T2 and T3 in that order as well as textstring T4 shown in comments or instructions location 1316. When the document based on template 1308 is printed, only document 1314 is normally printed.

In the normal course of use of document management system 1300, an editor or other user would select a pre-existing template, such as template 1308 for use in creating a custom document. Template 1308 may be displayed directly but preferably template table copy 1318 would be displayed. As shown in the figure, template table 1318 starts with the same contents as table 1310 and display 1320 would be the same as display 1312.

As a result of editing template table copy 1318, textstring T1 may be edited as shown in new textstring table 1322. Textstring T1 is edited and the edited version of textstring T1 is saved in textstring database 1304 as another textstring, such as textstring 5. In this example, textstring string T3, which may be modified with appropriate approval, is not modified. The document based on template table 1322 may be displayed as document 1326 and comments 1328 on display 1324. When printed, only document 1326 would be printed. Template table 1322 may preferably be saved in document archive 1306 as document 1330. Similarly, table 1322 may be saved as a template in template database 1308 so that it may be further edited or used as a template to create a different document.

While various embodiments have been described, they have been presented by way of example only, and not limitation. Thus, the breadth and scope of any embodiment should not be limited by any of the above described exemplary embodiments, but should be defined only in accordance with the following claims and their equivalents.

What is claimed:

1. A method for managing a document, comprising:
providing a database of text strings including words;
providing a document template in the form of a list of at least some of the text strings in the text string database,
the list including a first, a last and intermediate text strings, each text string in the list except the first providing a link to a prior text string and each text string in the list except the last providing a link to a subsequent text string,
each listed text string including attribute codes indicating
if the related text string may be edited,
if the related text string is required in a final document to be produced from the document template and
any approvals required for the modification of the text string for use in the document to be produced from the document template;
providing a user interface permitting a user to access and revise the document template;
saving the revised document template as new template;
saving revised text strings as new text strings in the text string database and revising the document template list to include such revised text strings; and
producing the document from the revised document template in accordance with the database of text strings.

2. The method of claim 1 wherein the list includes a global formatting command to be applied to the document to be produced from document template.

3. The method of claim 2 wherein at least some of the listed text strings include text string formatting commands to be applied to the related text strings in the documents to be produced from the document template.

4. The method of claim 1 wherein the attribute codes for at least some of the listed text strings indicate that the related text string is to be displayed to the user during revision of the document template but not included in the document to be produced from the revised document template.

5. The method of claim 1 further comprising:
automatically detecting a revision to a text string;
creating a copy of the text string being revised;
applying the revisions to the copy of the text string; and
updating the list so that the text string, prior to the text string being revised, provides a link to the revised text string as the subsequent text string.

6. The method of claim 1 further comprising:
maintaining an archival store of the text string database including saved revised text strings, the document template and the revised document template to provide an historical record of revisions made to the document and the ability to produce the document as revised at any point in a series of revisions.

7. The method of claim 1 wherein the user interface permits the user to access and revise the document template on a client computer and the text string database and document template are stored on a server computer connected by network to the client computer.

8. The method of claim 1, wherein the document is produced in a portable document format (PDF) file format.

9. The method of claim 1, wherein at least one text string is in a markup language file format.

10. The method of claim 1 wherein the list is a doubly linked list.

11. A document management system, comprising:
a database of text strings;
a plurality of document templates, each in the form of a list of text strings in the text string database, the list including a first, a last and intermediate text strings and each text string in the list except the first providing a link to a prior text string in the list and each text string in the list except the last providing a link to a subsequent text string in the list, each listed text string including attribute codes indicating if the related text string may be edited, if the related text string is required in a final document to be produced from the document template and any approvals required for the modification of the text string for use in the document to be produced from the document template;
a user interface providing access to revise at least one of the plurality of document templates; and
software controlling the user interface and saving the revised document template as a new template, saving revised text strings as new text strings in the text string database and revising the document template list to include such revised text strings and producing the document from the revised document template in accordance with the database of text strings.

12. The invention of claim 11 wherein the list includes a global formatting command to be applied to the document to be produced from the document template.

13. The invention of claim 12 wherein at least some of the listed text strings include text string formatting commands to be applied to the related text strings in the documents to be produced from the document template.

14. The invention of claim 11 wherein the attribute codes for at least some of the listed text strings indicates that the related text string is to be displayed to the user during revision of the document template but not included in the document to be produced from the revised document template.

15. The invention of claim 11 wherein the software further comprising:
software for automatically detecting a revision to a text string, creating a copy of the text string being revised, applying the revisions to the copy of the text string and updating the list so that the text string, prior to the text string being revised, provides a link to the revised text string as the subsequent text string.

16. The invention of claim 11 further comprising:
an archival store maintaining a copy of the text string database including saved revised text strings, the document template and the revised document template to provide an historical record of revisions made to the document and the ability to produce the document as revised at any point in a series of revisions.

17. The invention of claim 11 further comprising:
a client computer on which the user interface resides; and
a server computer, connected by network to the client computer, on which the text string database and document template are stored.

18. The invention of claim 11, wherein the document is produced in a portable document format (PDF) file format.

19. The invention of claim 11, wherein at least one test string is in a markup language file format.

20. The invention of claim 11 wherein the list is a doubly linked list.
